(19) United States
(12) Patent Application Publication
(10) Pub. No.: US 2024/0123858 A1
(43) Pub. Date: Apr. 18, 2024

(54) CHARGING SOCKET WITH VEHICLE-INTERNAL DATA BUS CONNECTION

(71) Applicant: PHOENIX CONTACT E-Mobility GmbH, Schieder-Schwalenberg (DE)

(72) Inventor: Markus Rose, Schlangen (DE)

(21) Appl. No.: 18/546,786

(22) PCT Filed: Feb. 7, 2022
(86) PCT No.: PCT/EP2022/052886

§ 371 Date: Aug. 17, 2023

(30) Foreign Application Priority Data
Feb. 18, 2021 (BE) BE2021/5113

(51) Int. Cl. B60L 53/66; B60L 53/16; H02J 7/00

(52) U.S. Cl. CPC B60L 53/66; B60L 53/16; H02J 7/0042; B60R 16/023

(57) ABSTRACT

A charging socket installed or installable in an electric vehicle for receiving a charging plug for charging a traction energy store of the electric vehicle with an electrical charging current, the charging socket including: power contacts for contacting corresponding power contacts of the charging plug in a state received in the charging socket for electrically conducting the charging current; charging technology-specific signal contacts for contacting corresponding signal contacts of the charging plug in a state received in the charging socket for controlling the charging current; a signal converter for transmitting and/or receiving control signals for controlling the charging current at the charging technology-specific signal contacts; and a bus node including a connection to a data bus, the bus node communicating via the data bus with a vehicle controller of the electric vehicle and to control the signal converter to: transmit the control signals as transmitted control signals.

### CROSS-REFERENCE TO PRIOR APPLICATIONS

This application is a U.S. National Phase application under 35 U.S.C. § 371 of International Application No. PCT/EP2022/052886, filed on Feb. 7, 2022, and claims benefit to Belgian Patent Application No. BE 2021/5113, filed on Feb. 18, 2021. The International Application was published in German on Aug. 25, 2022 as WO/2022/175128 under PCT Article 21(2).

### FIELD

The invention relates to a charging socket for charging an electric vehicle with a vehicle-internal data bus connection, a set of such charging sockets for charging according to various charging technologies with a uniform vehicle-internal data bus connection, and a vehicle controller in communication with the charging socket in the electric vehicle by means of the data bus.

### BACKGROUND

In the prior art, charging sockets are known that are connected to the vehicle controller via a wiring harness with a plurality of lines. The plurality of lines is used in each case to detect and control various contacts of the charging socket as well as sensors, signal generators and actuators on the charging socket.

The document EP 2 233 344 B1 describes such a charging socket, designated a charging device. An activation control unit is installed in the vehicle, which detects a pilot signal via the charging socket and controls a charging control unit as a function of the detected pilot signal.

However, control signals, such as the aforementioned pilot signal, at the signal contacts of the charging socket are specific to the charging technology for charging a traction energy storage device of the electric vehicle. A charging technology-specific mating face of the charging socket, in particular with charging technology-specific signal contacts, ensures that only a charging plug of a charging station designed for the charging technology can be received in the charging socket.

Electric vehicles in different world regions have to have charging sockets that fit the respective charging technology. This traditionally leads to a situation where the vehicle control system for each country variant has corresponding interfaces for generating and detecting the control signals according to different charging technologies, but only one of these interfaces is used and is connected to the charging socket specific to the charging technology.

### SUMMARY

In an embodiment, the present invention provides a charging socket installed or installable in an electric vehicle for receiving a charging plug for charging a traction energy store of the electric vehicle with an electrical charging current, the charging socket comprising: power contacts configured to contact corresponding power contacts of the charging plug in a state received in the charging socket for electrically conducting the charging current; charging technology-specific signal contacts configured to contact corresponding signal contacts of the charging plug in a state received in the charging socket for controlling the charging current; a signal converter configured to transmit and/or receive control signals for controlling the charging current at the charging technology-specific signal contacts; and a bus node comprising a connection to a data bus, the bus node being configured to communicate via the data bus with a vehicle controller of the electric vehicle and to control the signal converter to: transmit the control signals as transmitted control signals, the transmitted control signals corresponding to the communication via the data bus, and/or to receive the control signals as received control signals, the communication via the data bus corresponding to the received control signals.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 shows a schematic representation of a conventional charging socket and a conventional vehicle controller electrically connected via a conventional wiring harness;

FIG. 2 shows a schematic view of a charging socket and a vehicle controller which are electrically connected according to a first embodiment;

FIG. 3 shows a schematic view of a charging socket for a first charging technology and a vehicle controller, which are electrically connected according to the first embodiment;

FIG. 4 shows a schematic view of a charging socket for a second charging technology and a vehicle controller, which are electrically connected according to the first embodiment;

FIG. 5 shows a schematic view of a charging socket and a vehicle controller, which are electrically connected according to a second embodiment;

FIG. 6 shows a schematic view of a charging socket for the first charging technology and a vehicle controller, which are electrically connected according to the second embodiment;

FIG. 7 shows a schematic view of a charging socket for the second charging technology and a vehicle controller, which are electrically connected according to the second embodiment;

FIG. 8 shows a schematic view of an electric car with functional blocks for a charging socket for the first charging technology and a vehicle controller, which are electrically connected according to the second embodiment;

FIG. 9 shows a schematic view of a charging socket for the first charging technology according to the second embodiment;

FIG. 10 shows a schematic view of a charging socket for the second charging technology according to the second embodiment; and

FIG. 11 shows a schematic view of a charging socket for a third charging technology according to the second embodiment.

### DETAILED DESCRIPTION

In an embodiment, the present invention provides a technology that avoids the installation of unused functions and the associated resources.

Exemplary embodiments of the invention are described below with partial reference to the figures.

A first aspect relates to a charging socket that is installed or installable in an electric vehicle for receiving a charging plug for charging a traction energy storage device of the electric vehicle with an electric charging current. The charging socket comprises power contacts which are designed to contact corresponding power contacts of the charging plug in the state received in the charging socket for electrically conducting the charging current. The charging socket further comprises charging technology-specific signal contacts which are designed to contact corresponding signal contacts of the charging plug in the state received in the charging socket for controlling the charging current. The charging socket further comprises a signal converter which is designed to transmit and/or receive control signals for controlling the charging current at the charging technology-specific signal contacts of the charging socket. The charging socket further comprises a bus node which comprises a connection to a data bus and is designed to communicate via the data bus with a vehicle controller of the electric vehicle. The bus node is further configured to control the signal converter to transmit the control signals, wherein the transmitted control signals correspond to the communication via the data bus, and/or to receive the control signals, wherein the communication via the data bus corresponds to the received control signals.

Due to the data bus, which does not necessarily have to be charging technology-specific, an exemplary embodiment of a charging technology-specific charging socket can be combined with an exemplary embodiment of a charging technology-nonspecific vehicle controller in an electric vehicle. Optionally, one or more functions of the charging socket can be controlled and/or read out by the bus node of the charging socket in communication with the vehicle controller.

The charging socket on the electric vehicle can also be referred to as a vehicle inlet (or inlet, for short).

The bus node to the data bus can comprise a modulator for transmitting data on the data bus and/or a demodulator for receiving data from the data bus (together also referred to as a modem).

The bus node and the signal converter can be part of a control unit of the charging socket. For example, the signal converter can be integrated into the bus node. The bus node can be designed to communicate with the controller of the electric vehicle.

The electric vehicle can be a battery electric vehicle (BEV). The charging technology can be designed in accordance with an (for example, international, regional or national) charging standard for electric vehicles.

The transmitted and/or received control signals may correspond to data in one or more Protocol Data Units (PDUs) of the communication over the data bus. For example, the control signals are contained in a service data unit (SDU) of the PDU.

The bus node can convert the data of the communication via the data bus by means of the signal converter into the transmitted control signals in an unprocessed manner, or can uniquely map it to the transmitted control signals. Alternatively or additionally, the bus node can convert the control signals received by means of the signal converter into the data of the communication via the data bus in unprocessed fashion, or can map them uniquely to the data of the communication.

The bus node can receive the data frame of the communication via the data bus from the vehicle controller. In response to the received data frame, the bus node can control the signal converter to send the control signals. Alternatively or additionally, the signal converter can receive the control signals at the signal contacts. In response to receiving the control signals, the bus node can send the data frame of the communication via the data bus to the vehicle controller.

The data frame can also be referred to in technical language as a “data frame.” The data frame can be a protocol data unit (PDU) on the data link layer (layer 2) of the communication on the data bus. The data frame can be an Ethernet data frame.

An arrangement of the power contacts and/or the signal contacts (i.e., a mating face) of the charging plug can correspond to the charging technology (for example uniquely).

The charging plug can be electrically and mechanically connected to the charging socket in the state received in the charging socket. The power contacts and the signal contacts can be designed for electrical connection. A locking mechanism can be designed to lock the charging plug against removal in the received state. The locking mechanism can comprise an actuator (also: actuator system) which is designed to selectively lock and unlock the charging plug by means of the locking mechanism (i.e., release it for removal).

The charging plug can be part of a charging station. The charging station can be a (for example free-standing) charging column or a wall arrangement (so-called wall box). Alternatively or additionally, the charging plug can be connected to the charging station via a charging cable. The charging cable can be pluggably connected or detachably connected to the charging station (optionally via an adapter), or the charging cable can be connected to the charging station without tools and so as not to be detachable without damage.

Here, the charging of the traction energy store (or the charging current for charging) can include charging the traction energy store and/or discharging the traction energy store. For example, the traction energy storage can be discharged to adapt electrochemical properties (for example, due to an aging state) of electrochemical storage cells for storing electrical energy in the traction energy store. Alternatively or additionally, the traction energy store of the (for example parked) electric vehicle (during charging and/or discharging) can be a buffer store of a local energy supply system (for example a household photovoltaic system).

A communication protocol of the communication on the data bus can be charging technology-independent. Alternatively or additionally, a signal protocol of the transmitted and/or received control signals at the signal contacts can charging technology-specific. The signal protocol of the control signals at the signal contacts can correspond to a charging method.

The charging technology of the charging socket or charging plug (for example, the mating face) can imply the signal protocol. For example, an arrangement of power contacts and/or signal contacts according to the Combined Charging System (CCS) charging technology may imply a signal protocol according to the charging method in Part 3 of the IEC 62196 standard (i.e., EN 62196).

Different arrangements of the power contacts and/or signal contacts can imply the same signal protocol of the control signals at the signal contacts. For example, an arrangement according to SAE J1772 or connector type-1 or combo-1 of the IEC 62196-1 standard and an arrangement according to VDE-AR-E 2623-2-2 or connector type-2 or combo-2 of the IEC 62196-1 standard may imply the same signal protocol.

The data bus, for example the data frame and/or the communication protocol of the communication on the data bus, can be designed according to a Controller Area Network (CAN), a Local Interconnect Network (LIN) or a local data network (for example Ethernet).

The LIN can also be referred to as LIN bus. The LIN (for example in version 2.2A of the specification) can be designed according to the ISO standard 17987-1 (for example for road vehicles).

The CAN can also be referred to as CAN bus. The CAN can be designed according to the ISO standards family 11898 (for example with regard to the layer 1, i.e., the physical layer, and/or the layer 2, i.e., data security layer). For example, the physical layer of the CAN can be designed according to ISO standard 11898-2 (high-speed CAN), ISO standard 11898-3 (low-speed CAN), or ISO standard CAN FD ISO 11898-1 (for a flexible data rate, FD, to increase the data rate in expansion of the CAN standard).

The data bus, for example the data frame of the communication on the data bus and/or the communication protocol of the communication on the data bus, can be designed according to Ethernet or the IEEE standards family 802.3. The physical layer of the data bus may comprise a line pair, for example according to automotive Ethernet.

The data bus can comprise only one, or a single, line pair. Alternatively or additionally, the data bus can be designed for example according to CAN, CAN-FD, Local Interconnect Network (LIN), FlexRay or Ethernet (especially single-pair Ethernet or automotive Ethernet).

The charging socket can further comprise a power supply which is electrically conductively connected or can be connected to an on-board electrical system and is designed to feed at least the bus node and/or the signal converter with electrical power from an onboard power supply system. The power supply can comprise a DC voltage converter.

The bus node can also be designed to output an identification of the charging technology of the charging socket to the vehicle controller via the data bus.

The vehicle controller of the electric vehicle can comprise a charging controller (for example an on-board charger, OBC) for controlling the charging current when charging the traction energy store and/or a battery management system (BMS) of the traction energy store.

The control signals of the charging technology-specific signal contacts can include pilot signals, for example at least one control pilot signal (also: control pilot or CP) for controlling the charging current and/or a proximity pilot signal (also: proximity pilot or PP), and/or a connection check (also: connection status or CS) for determining the state of the charging plug received in the charging socket.

The control signals of the charging technology-specific signal contacts can comprise data bus signals, preferably data bus signals of a power line communication (PLC) and/or data bus signals of a controller area network (CAN).

The charging socket can include a plurality of functions. The bus node can also be designed to control each of the functions in the communication (for example in accordance with the communication via the data bus) and/or to query each of the functions (and for example to communicate the results of the query via the data bus).

The bus node can include an electronic driver to control each of the functions. Alternatively or additionally, the bus node can include an analog-to-digital converter (A/D converter) for querying the functions.

The charging socket may comprise functions within the charging socket, for example a temperature sensor for detecting a temperature of the power contacts or of each power contact for alternating current and/or a temperature sensor for detecting a temperature of the power contacts or of each power contact for direct current. Alternatively or additionally, the charging socket can comprise functions at the charging socket, for example a locking of a charging flap of the charging socket driven by an actuator and/or a locking of the charging plug, driven by an actuator, in the state received in the charging socket.

Another aspect relates to a set of charging sockets. The set of charging sockets comprises at least one charging socket according to the first-mentioned aspect, wherein the charging technology-specific signal contacts and/or the signal protocol of the control signals at the charging technology-specific signal contacts correspond to a first charging technology. Further, the set of charging sockets comprises at least one charging socket according to the first-mentioned aspect, wherein the charging technique-specific signal contacts and/or the signal protocol of the control signals at the charging technique-specific signal contacts correspond to a second charging technique that is different from the first charging technique.

The charging technology can comprise a charging method and/or an arrangement of the power and signal contacts. The charging technology can be regionally- or country-specific. Embodiments of the charging sockets according to the first and second charging technology can also be referred to as country variants.

The charging technology can include a first charging technology, for example for Europe, the European Union (EU), North America, or the United States of America (USA). The first charging technology can be a combined charging system (CCS), for example according to the European variant Combo-2 or the North American variant Combo-1.

The charging technology may include a second charging technology, for example for China (CN) or Japan (JP). The second charging technology can correspond to a CHAdeMO or ChaoJi charging system.

A still further aspect relates to a vehicle controller installed or installable in an electric vehicle for controlling charging of a traction energy store of the electric vehicle with an electric charging current through a charging socket of the electric vehicle. The vehicle controller comprises a power connection to an on-board network of the electric vehicle, which is designed to supply electrical power to a signal converter and a bus node of the charging socket, whereby the signal converter is operable to send and/or receive control signals at charging technology-specific signal contacts of the charging socket to control the charging current. Furthermore, the vehicle controller comprises a bus node of the one connection to a data bus and is designed to communicate via the data bus with the bus coupler of the charging socket. As a result, the bus node is operable to control the signal converter to transmit the control signals, wherein the transmitted control signals correspond to the communication via the data bus, and/or to receive the control signals, wherein the communication via the data bus corresponds to the received control signals.

The vehicle controller may further comprise any feature disclosed in the context of the first-mentioned aspect or the further aspect, or a feature corresponding thereto.

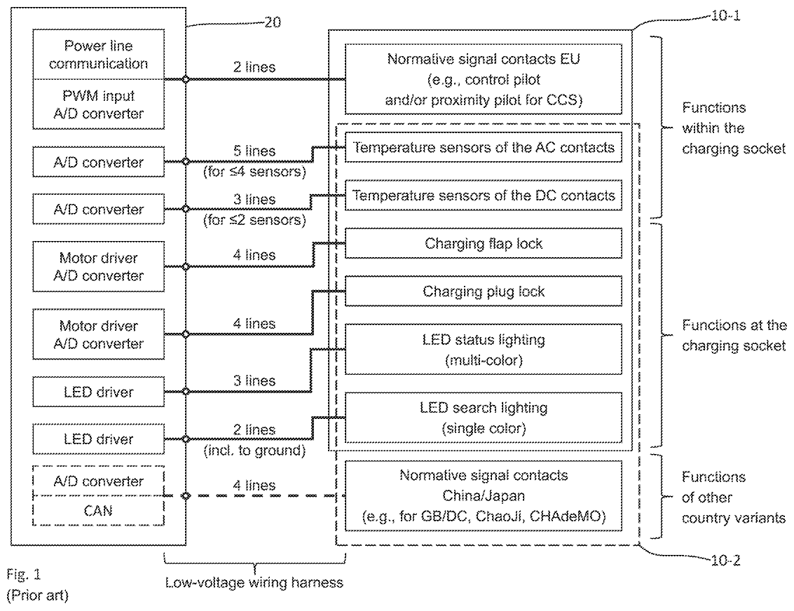

FIG. 1 shows, in block schematic view, a conventional charging socket 10-1 for a first charging technology and a conventional second charging socket 10-2 for a second charging technology, which is different from the first with respect to normative signal contacts. The conventional charging sockets 10-1 or 10-2 must each be electrically conductively connected to the conventional vehicle controller 20 via a complex wiring harness.

The conventional charging socket 10-1 or 10-2 is connected to the higher-level vehicle controller 20 via a low-voltage wiring harness. Electrical functions of the charging socket 10-1 or 10-2, including assemblies in the immediate vicinity of the charging socket, are conventionally controlled via such a wiring harness.

As can be seen from the reference example of FIG. 1, a sufficient quantity of inputs and outputs, including the associated electronics and control software (for example signal protocols of the control signals) for controlling and detecting the control signals of different charging technologies, must be held available in the conventional vehicle controller 20. For example, the interface shown in dashed lines for control signals of a second charging technology (e.g., for China or Japan) of the vehicle controller 20 is unused when the vehicle controller 20 is connected to the charging socket 10-1 for a first charging technology (e.g., for Europe or North America).

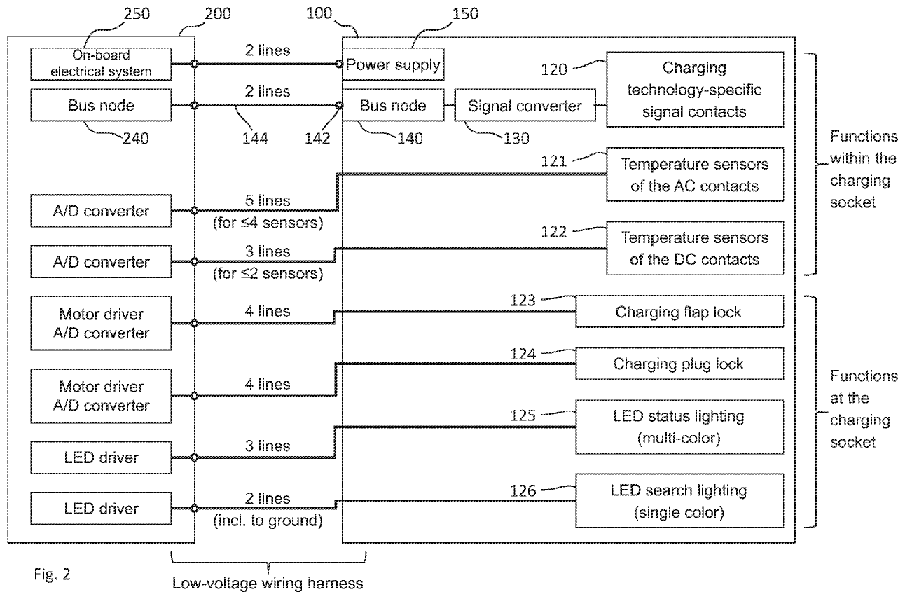

FIG. 2 schematically shows a charging socket 100 for a charging technology and a vehicle controller 200 according to a first embodiment.

The charging socket 100 is installed or installable in an electric vehicle. The charging socket 100 is designed to receive a charging plug for charging a traction energy store of the electric vehicle with an electrical charging current. For this purpose, the charging socket 100 comprises power contacts which are designed to contact corresponding power contacts of the charging plug in the state received in the charging socket 100 for electrically conducting the charging current. The charging socket 100 further comprises charging technology-specific signal contacts 120 which are designed to contact corresponding signal contacts of the charging plug in the state received in the charging socket 100, for controlling the charging current. The charging socket 100 further comprises a signal converter 130 which is designed to transmit and/or receive control signals for controlling the charging current at the charging technology-specific signal contacts 120 of the charging socket 100. The charging socket 100 further comprises a bus node 140 which comprises a connection 142 to a data bus 144 and is designed to communicate via the data bus 144 with a vehicle controller 200 of the electric vehicle. The bus node 140 controls the signal converter 130 to transmit the control signals, wherein the transmitted control signals correspond to the communication via the data bus 144. For example, the data obtained via the data bus at the bus node 140 specify the control signals to be sent. Alternatively or additionally, the bus node 140 controls the signal converter 130 to receive the control signals, wherein the communication via the data bus 144 corresponds to the received control signals. For example, the bus node 140 forwards the received control signals as data (for example as user data in a data frame) to the vehicle controller 200 via the data bus 144.

The first exemplary embodiment of the vehicle controller 200 is installed or installable in an electric vehicle. The vehicle controller 200 is designed to control the charging of a traction energy store of the electric vehicle with an electrical charging current through a charging socket 100 of the electric vehicle. The vehicle controller 200 comprises a power connection to an on-board network 250 of the electric vehicle, which is designed to supply electrical power to a signal converter 130 and a bus node 140 of the charging socket 100, whereby the signal converter 130 is operable to send and/or receive control signals at charging technology-specific signal contacts 120 of the charging socket 100 to control the charging current. Further, the vehicle controller 200 comprises a bus node 240 comprising a connection to a data bus 144 and designed to communicate with the bus coupler 140 of the charging socket 100 via the data bus 144, whereby the bus node 140 is operable to control the signal converter (130) to transmit the control signals, wherein the transmitted control signals correspond to the communication via the data bus 144. Alternatively or additionally, the bus node 140 is operable to control the signal converter 130 to receive the control signals, wherein the communication via the data bus 144 corresponds to the received control signals.

Embodiments of the charging socket 100 and/or the vehicle controller 200 can be assemblies, supplied to automobile manufacturers, of electric vehicles.

The data bus 144 can be a CAN bus, an Ethernet, preferably single-pair Ethernet or automotive Ethernet, a Local Interconnect Network (LIN, also called LIN bus), or a field bus for use in an automobile, preferably FlexRay.

Because of the data bus 144, which does not necessarily have to be charging technology-specific, embodiments of the invention can meet internationally differing normative requirements (for example, for the control signal and signal contacts 120) without requiring the vehicle controller 200 to hold available electronics for individually controlling different variants of the charging sockets 10-1 and 10-2 (that is, conventional charging sockets for different charging technologies).

The different charging technologies can relate to a Chinese standard (e.g., GB/AC, GB/DC, ChaoJi), the Japanese standard (e.g., CHAdeMO), and/or the European standard (e.g., Combined Charging System, CCS). The same vehicle controller can be installed in the electric vehicle in all country variants. Depending on the country of use, the charging socket 100 is installed in accordance with the charging technology, which means that no functions that are not required remain installed in the electric vehicle.

The first exemplary embodiment of the charging socket 100 or of the vehicle controller 200 can already avoid the need for keeping available different country variants for different target markets (for example, Europe, America and Asia), different communication interfaces (CAN bus and power line communication), and a different number of signal contacts 120 (for example as connection options or interfaces) in the vehicle controller 200. This reduces the complexity and thus the costs of the vehicle controller 200. In addition, different wiring harnesses are not required for the different country variants.

For example, the communication interfaces and country-specific components of the conventional vehicle controller 20 are integrated into the charging socket 100 only to the extent associated with the charging technology in each case. Alternatively or additionally, the data bus 144 is a uniform country-independent communication interface between the vehicle controller 200 and the charging socket 100. The country-specific variance can thereby be minimized to one assembly, namely the respective country-specific charging socket 100.

In each embodiment, the charging socket 100 can include functions within the charging socket and/or functions at the charging socket 100 (for example, functions in the environment of the charging socket or functions protecting the charging socket). For example, in each exemplary embodiment the charging socket 100 can comprise at least one of the following functions. The charging socket 100 can sensors 121 and/or 122 for detecting the temperature at power contacts (for example, for AC or DC) during charging (i.e., during the charging process). Alternatively or additionally, the charging receptacle 100 can comprise actuator means 124 for locking the charging plug, such as a sensor for detecting the locking position and/or unlocking position and an actuator for driving the lock between the locking position and the unlocking position. Alternatively or additionally, the charging socket 100 can comprise lighting means (preferably light-emitting diodes, LEDs) as status lighting 125 and/or search illumination 126. Alternatively or additionally, the charging receptacle 100 can comprise a lock 123 of a charging flap (analogous to the former fuel tank flap in internal combustion-powered vehicles), for example, a sensor for detecting the locking position and/or unlocking position of the lock 123 of the charging flap and an actuator for driving the lock 123 between the locking position and the unlocking position.

Depending on the charging technology (for example, depending on the country variant), the normatively required signal lines 120 and the associated signal protocol can include control signals such as Control Pilot and Proximity Pilot, or control signals for higher data rates or more complex messages (for example, PLC for a first charging technology or CAN bus for a second charging technology).

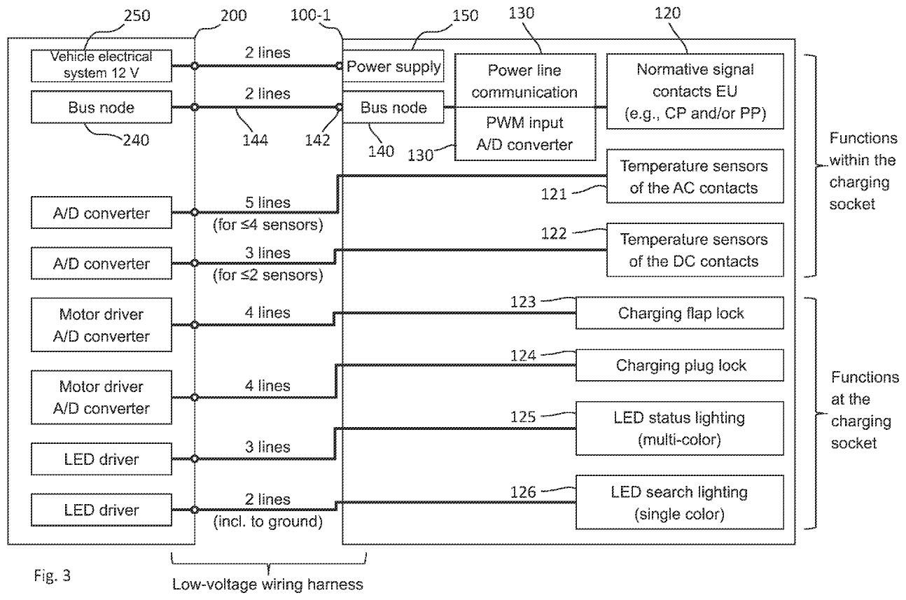

FIG. 3 shows a first variant 100-1 of the first exemplary embodiment of the charging socket 100 for a first charging technology. The first loading technique includes normatively required signal contacts 120 for Control Pilot (CP) and Proximity Pilot (PP) connected to an input for detecting a pulse-width modulation (as an example of signal converter 130). Furthermore, the first charging technology at least partially uses the signal contacts 120 (for example the signal contact 120 for CP) to the PLC. For this purpose, the signal contacts 120 are further connected to a PLC modem (as a further example of the signal converter 130).

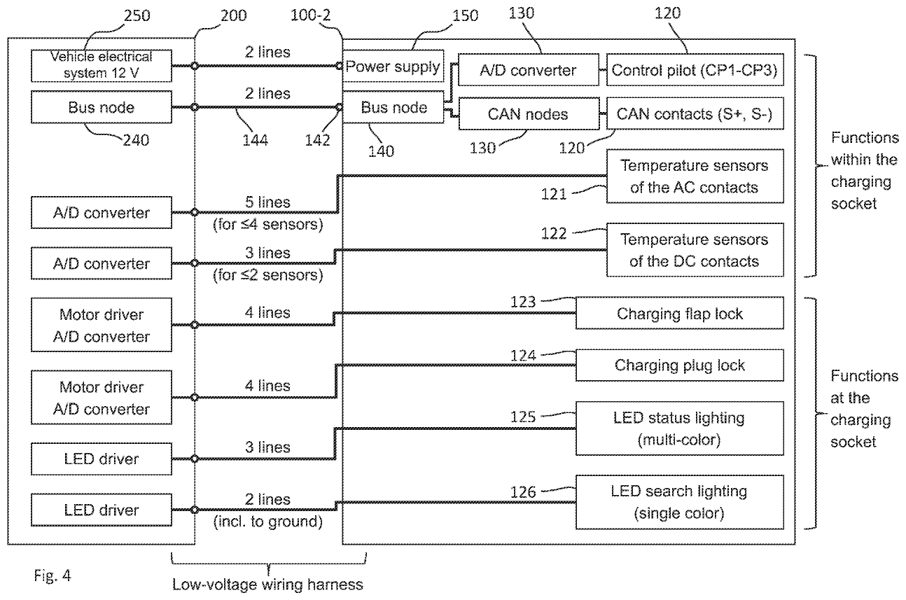

FIG. 4 shows a second variant 100-2 of the first exemplary embodiment of the charging socket 100 for a second charging technology. The second loading technique comprises normatively required (for example country-specific) signal contacts 120 (and/or for example for Control Pilot CP1 to CP3) which are connected to an analog-to-digital converter (as an example of signal converter 130). Alternatively or additionally, the second charging technology uses the further signal contacts 120 (for example signal contact S+ and S−) for a CAN bus. For this purpose, the further signal contacts 120 are connected to a CAN modem (as a further example of the signal converter 130).

Returning to the reference example of FIG. 1 mentioned earlier, it can further be seen from this that more than 20 signal lines are required to connect the conventional charging socket 10-1 or 10-2 (including the necessary components for the electrical functions) to the higher-level vehicle controller 20.

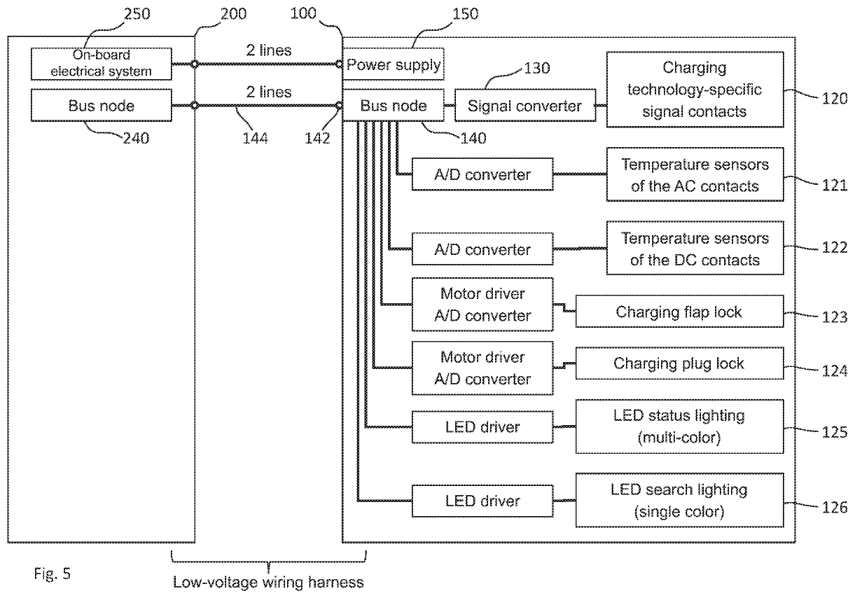

The charging socket 100 or the vehicle controller 200 according to a second embodiment shown schematically in FIG. 5 differs from the first embodiment in that at least a portion of the electrical functions 121 to 126 of the charging socket 100 are controlled and/or evaluated by the bus node 140. For this purpose, the electronics and/or control software required for the named functions 121 to 126 can be implemented in the second embodiment of the charging socket 100 instead of in the conventional vehicle controller 20.

For this purpose, electronics and control software can be installed in the charging socket 100. For example, the bus node 140 has a processor and a memory in data communication with the processor, in which instructions are encoded based on which, when executed by the processor, the charging socket controls and/or detects (for example queries) at least one of the functions 121 to 126, preferably in communication with the vehicle controller 200 via the charging technology-nonspecific data bus 144.

The electronic assemblies for controlling and/or detecting the functions are placed directly in the charging socket 100 while maintaining necessary distances for insulation from the high-voltage-conducting parts, for example the power contacts. The communication with the vehicle controller takes place via a vehicle-typical data bus 144 (i.e., a communication bus), e.g., CAN, LIN, Ethernet, or others. This results in a considerable reduction in the number of lines, and simplifies installation.

Alternatively or additionally, the second exemplary embodiment can reduce the costs for the development and production of the vehicle controller 200. Alternatively or additionally, the vehicle controller 200 can be installed independently of an export region of the electric vehicle in an earlier manufacturing process step (for example together with driver assistance functions). Furthermore, the elimination of unused interfaces and functions can improve the power consumption and reliability of the vehicle controller 200.

Alternatively or additionally, according to the second exemplary embodiment, individual or all functions from the surrounding environment of the charging socket 100 can be integrated into the charging socket 100. As a result, an installation space of the vehicle controller 200 can be reduced compared to the conventional vehicle controller 20, and a space requirement of the data bus 144 can be reduced compared to the conventional wiring harness of FIG. 1.

Alternatively or additionally, electronics and control software of the vehicle controller 200 can be simplified and costs of their development and production can be reduced. Reducing the number of lines between vehicle controller 200 and charging socket 100 can enable faster assembly and greater reliability.

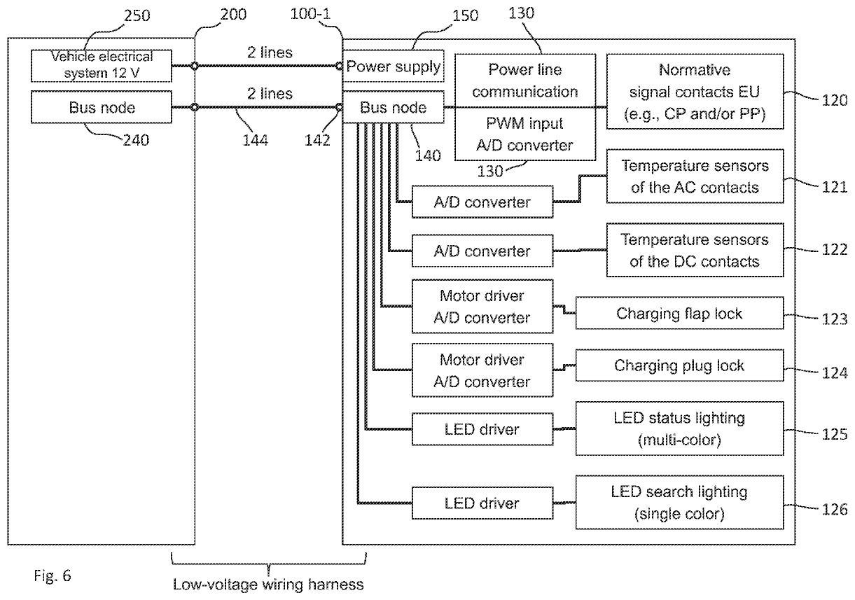

FIG. 6 shows a first variant 100-1 of the second embodiment of the charging socket 100 for the first charging technology. According to the first charging technology, signal contacts 120 for CP and PP are connected to an input for detecting a pulse-width modulation (as an example of the signal converter 130). Furthermore, the first charging technology uses the CP signal contact 120 to the PLC, by connecting a PLC modem (as another example of signal converter 130) controlled by the bus node 140 to the CP signal contact 120.

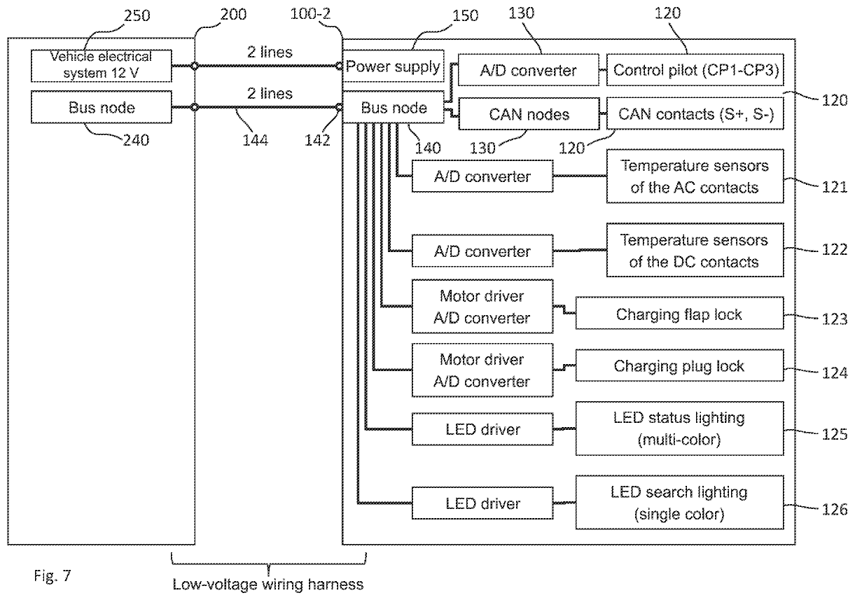

FIG. 7 shows a second variant 100-2 of the second exemplary embodiment of the charging socket 100 for the second charging technology. The second charging technology can comprise signal contacts 120, which are designated here by way of example as CP1 to CP3, and which are connected to an analog-to-digital converter (as an example of signal converter 130) controlled by the bus node 140. Alternatively or additionally, the second charging technology uses the further signal contacts 120 (for example signal contact S+ and S−) for a CAN bus. For this purpose, the further signal contacts 120 are connected to a CAN modem (as a further example of the signal converter 130).

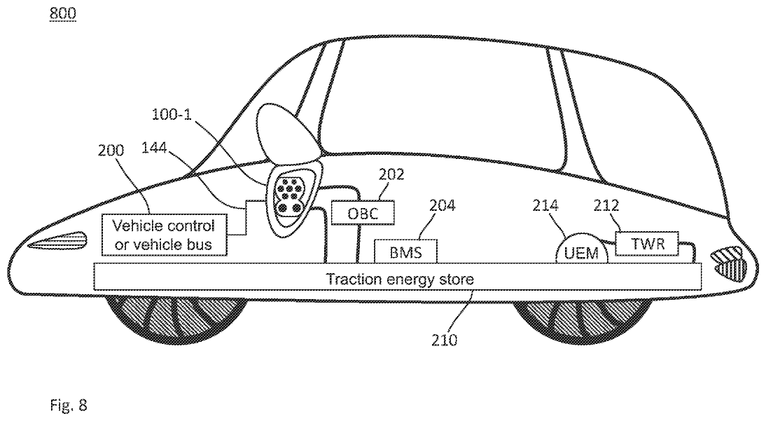

FIG. 8 shows a schematic view of an electric car 800 with functional blocks for a charging socket 100 for the first charging technology and a vehicle controller 200, which are electrically connected according to the second embodiment. While the electric vehicle is shown for the first charging technology and second embodiment (connected exclusively via the data bus 144), features of the first embodiment and/or of another charging technology may be implemented instead or in addition.

The DC power contacts of the charging socket 100 can be electrically conductively connected directly to the traction energy store 210 or to a battery management system (BMS) 204 of the traction energy store 210. Alternatively or additionally, the AC power contacts of the charging socket 100 can be electrically conductively connected to the traction energy store 210 via an on-board charging controller 202 (also: on-board charger, OBC).

Via a traction inverter (TWR) 214, the traction energy store 210 feeds an electric motor 212 or recuperates kinetic energy of the electric vehicle 800 from the electric motor 212. An output shaft of the electric motor 212 drives at least one axle of the electric vehicle 800.

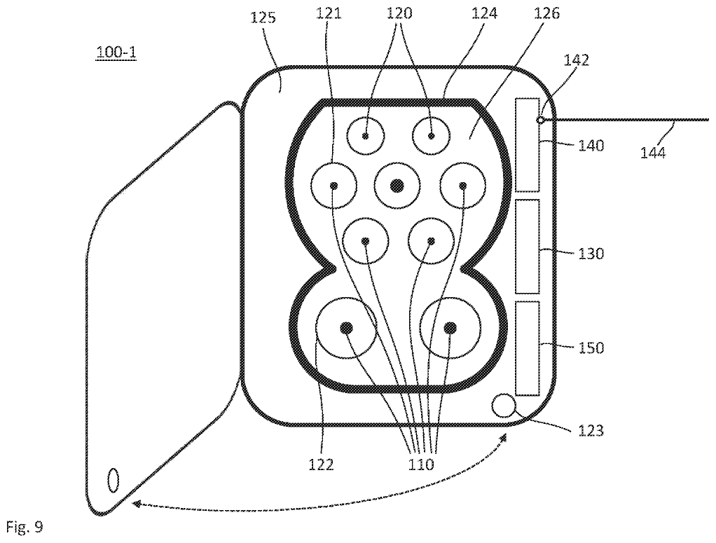

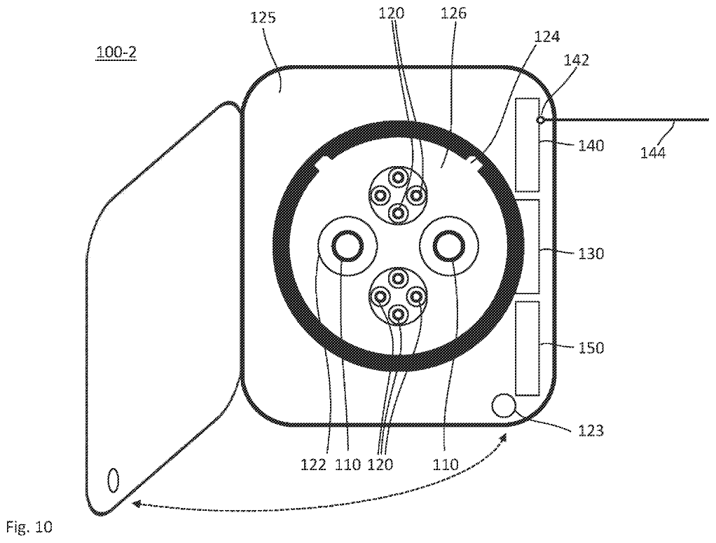

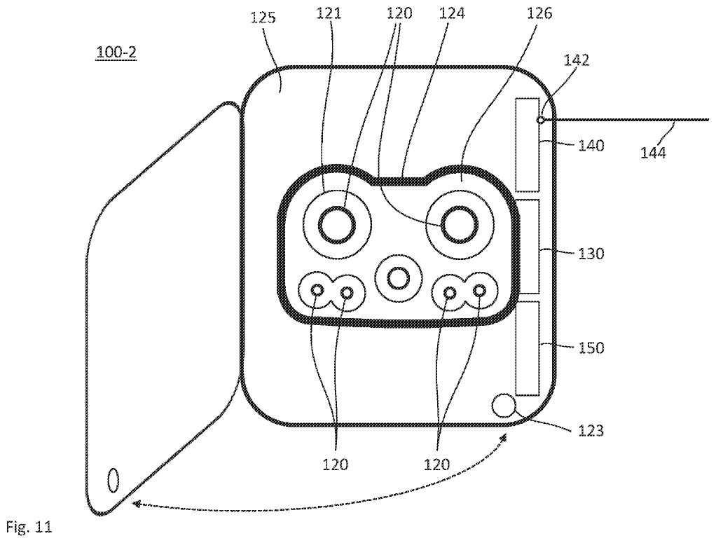

FIG. 9 shows a schematic view of a charging socket 100-1 for the first charging technology, for example CCS, according to the second embodiment. FIG. 10 shows a schematic view of a charging socket 100-2 for the second charging technology, for example CHAdeMO, according to the second embodiment. FIG. 11 shows a schematic view of a charging socket 100-2 for a third charging technology or a third version of the second charging technology, for example ChaoJi, according to the second embodiment.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

Conventional charging socket with EU charging technology 10-1
Conventional charging socket with JP/CN charging technology 10-2
Conventional vehicle controller with EU and JP/CN charging technology 20
Charging socket according to a charging technology 100
Charging socket according to first charging technology, for example country variant for EU 100-1
Charging socket according to second charging technology, for example country variant for JP or CN 100-2
Power contacts 110
Charging technology-specific signal contacts 120
Temperature sensors of the AC power contacts 121
Temperature sensors of the DC power contacts 122
Charging flap lock 123
Charging plug lock 124
Status lighting, preferably multicolored 125
Search illumination, preferably single-color 126
Signal converter of the charging socket 130
Bus node of the charging socket 140
Connection of the charging socket to the data bus 142
Data bus 144
Power supply of the charging socket 150
Vehicle controller 200
On-board charging control (also: on-board charger, OBC) 202
Battery management system (BMS) 204
Traction energy store 210
Electric motor 212
Traction inverter (TWR) 214
Bus node of the vehicle controller 240
On-board electrical system of the electric vehicle for low-voltage supply 250
Electric vehicle 800

1. Charging A charging socket installed or installable in an electric vehicle for receiving a charging plug for charging a traction energy store of the electric vehicle with an electrical charging current, the charging socket comprising:
power contacts configured to contact corresponding power contacts of the charging plug in a state received in the charging socket for electrically conducting the charging current;
charging technology-specific signal contacts configured to contact corresponding signal contacts of the charging plug in a state received in the charging socket for controlling the charging current;
a signal converter configured to transmit and/or receive control signals for controlling the charging current at the charging technology-specific signal contacts; and
a bus node comprising a connection to a data bus, the bus node being configured to communicate via the data bus with a vehicle controller of the electric vehicle and to control the signal converter to:
transmit the control signals as transmitted control signals, the transmitted control signals corresponding to the communication via the data bus, and/or
to receive the control signals as received control signals, the communication via the data bus corresponding to the received control signals.

2. The charging socket of claim 1, wherein the transmitted and/or received control signals correspond to data in a data frame of the communication via the data bus.

3. The charging socket of claim 2,
wherein the bus node is configured to receive the data frame of the communication via the data bus from the vehicle controller and, in response to the received data frame, to control the signal converter to send the control signals, and/or
wherein the signal converter is configured to receive the control signals at the signal contacts, and, in response to receiving the control signals the bus node, to send the data frame of the communication to the vehicle controller via the data bus.

4. The charging socket of claim 1,
wherein a communication protocol of the communication on the data bus is charging technology-independent, and/or
wherein a signal protocol of the transmitted and/or received control signals at the signal contacts is charging technology-specific.

5. The charging socket of claim 1, wherein the data bus, is configured as:
a Controller Area Network (CAN),
a Local Interconnect Network (LIN), or
a local data network.

6. The charging socket of claim 5, wherein the data bus comprises only one line pair.

7. The charging socket of claim 1, further comprising:
a power supply electrically conductively connected or connectable to an on-board electrical system, the power supply being configured to feed at least the bus node and/or the signal converter with electrical power from an onboard electrical system.

8. The charging socket of claim 1, wherein the bus node is configured to output an identifier of a charging technology of the charging socket to the vehicle controller via the data bus.

9. The charging socket of claim 1, wherein the vehicle controller of the electric vehicle comprises a charging controller configured to control the charging current when charging the traction energy store and/or a battery management system of the traction energy store.

10. The charging socket of claim 1, wherein the control signals of the charging technology-specific signal contacts comprise pilot signals for controlling the charging current and/or a proximity pilot signal (PP) or a connection check (CS), for determining a state of the charging plug received in the charging socket.

11. The charging socket of claim 1, wherein the control signals of the charging technology-specific signal contacts comprise data bus signals.

12. The charging socket of claim 1, wherein the charging socket comprises a plurality of functions and the bus node is configured to, in accordance with the communication via the data bus, control the functions and/or to query each function of the functions and to communicate the results of the query via the data bus.

13. The charging socket of claim 12, wherein the charging socket comprises functions within the charging socket.

14. The charging socket of claim 12, wherein the charging socket comprises functions at the charging socket.

15. A set of charging sockets, comprising:
at least one charging socket of claim 1, wherein the charging technology-specific signal contacts and/or a signal protocol of the control signals at the charging technology-specific signal contacts correspond to a first charging technology; and
at least one charging socket of claim 1, wherein the charging technology-specific signal contacts and/or a signal protocol of the control signals at the charging technology-specific signal contacts correspond to a second charging technology different from the first charging technology.

16. A vehicle controller installed or installable in an electric vehicle for controlling charging of a traction energy store of the electric vehicle with an electrical charging current through a charging socket of the electric vehicle, the vehicle controller comprising:
a power connection to an onboard electrical system of the electric vehicle configured to feed a signal converter and a bus node of the charging socket with electrical power, the signal converter being operable to send and/or receive control signals for controlling the electrical charging current at charging technology-specific signal contacts of the charging socket; and
a bus node comprising a connection to a data bus, the bus node being configured to communicate via the data bus with the bus coupler of the charging socket, the bus node being operable to control the signal converter to:
transmit the control signals as transmitted control signals, the transmitted control signals corresponding to the communication via the data bus, and/or
to receive the control signals as received control signals, the communication via the data bus corresponding to the received control signals.

17. The charging socket of claim 5, wherein the data frame and/or the communication protocol of the communication on the data bus is configured as:
the CAN,
the LIN, or
the local data network.

18. The charging socket of claim 17, wherein CAN comprises a CAN with a flexible data rate (CAN-FD), and
wherein the local data network comprises automotive Ethernet.

19. The charging socket of claim 6, wherein the only one line pair comprises single-pair Ethernet, automotive Ethernet, CAN, or a CAN with a flexible data rate (CAN-FD).

20. The charging socket of claim 10, wherein the pilot signals comprise at least one control pilot signal (CP).
